(19) United States
(12) Patent Application Publication
(10) Pub. No.: US 2021/0204548 A1
(43) Pub. Date: Jul. 8, 2021

(54) Stabilized Biocide Composition

(71) Applicant: Thor GmbH, Speyer (DE)

(72) Inventors: Stefan Apenberg, Zeiskam (DE); Rüdiger Baum, Neulussheim (DE)

(73) Assignee: Thor GmbH, Speyer (DE)

(21) Appl. No.: 16/068,761

(22) PCT Filed: Mar. 28, 2018
(86) PCT No.: PCT/EP2018/000132

§ 371 Date: Jul. 9, 2018

(30) Foreign Application Priority Data
Apr. 4, 2017 (EP) 17000561.5

(51) Int. Cl. A01N 43/80; A01N 25/22

(52) U.S. Cl. CPC A01N 43/80; A01N 25/22

(57) ABSTRACT

The present invention relates to stabilized compositions, or compositions that are stable when stored, comprising: (A) 2.5 to 15% by weight of the isothiazolinone 2-methyl-2H-isothiazolin-3-one and 1,2-benzisothiazolin-one and/or its sodium and/or potassium salt, (B) 0.5 to 50 ppm by weight of copper(II) ions, in relation to the weight fraction of component (A), (C) 100 to 2,500 ppm by weight, in relation to the total composition, of at least one oxidizing agent selected from the group consisting of sodium iodate, potassium iodate, sodium bromate and potassium bromate, or mixtures of these and (D) water. The invention further relates to a process for the preservation of technical materials by means of the aforementioned compositions, as well as the technical materials treated therewith.

The present invention relates to stabilized compositions, or compositions that are stable when stored, comprising: (A) 2.5 to 15% by weight of the isothiazolinone 2-methyl-2H-isothiazolin-3-one and 1,2-benzisothiazolin-one and/or its sodium and/or potassium salt, (B) 0.5 to 50 ppm by weight of copper(II) ions, in relation to the weight fraction of component (A), (C) 100 to 2,500 ppm by weight, in relation to the total composition, of at least one oxidizing agent selected from the group consisting of sodium iodate, potassium iodate, sodium bromate and potassium bromate, or mixtures of these and (D) water. The invention further relates to a process for the preservation of technical materials by means of the aforementioned compositions, as well as the technical materials treated therewith.

In literature, various methods are described for protection of isothiazolinones from chemical decomposition and for stabilizing biocidal compositions. Typically, this involves the stabilization of 3:1 mixtures of 5-chloro-2-methyl-4-isothiazolin-3-one (CMIT) and methyl-4-isothiazolin-3-one (MIT), such as those that typically arise in large-scale production. The highly reactive CMIT must be stabilized, while MIT is largely stable under application or storage conditions.

European published patent application EP 0 721 736 A1 describes, for example, stabilized isothiazolinone compositions of CMIT and MIT in which the stabilization is achieved by non-chelated copper(II) ions, whereat the weight ratio of copper(II) ions and isothiazolinones is preferably in the range of 0.02 to 1.5.

Moreover, European Patent Application EP 0 749 689 A1 teaches how to prevent precipitation in isothiazolinone compositions by way of adding copper(II) ions and metal nitrates. In this case, 0.1 to 25% metal nitrates, such as magnesium nitrate, and about 0.1 to 100 ppm of copper(II) ions are added for stabilization.

Furthermore, the European published patent application EP 1 369 461 A1 has also already disclosed that the degradation of isothiazolinones in aqueous paint systems can be slowed down by using 1 to 200 ppm of copper(II) ions for stabilization. In relation to the isothiazolinones, however, the amounts of copper are comparatively high here.

Furthermore, European published patent applications EP 1 044 609 A1, EP 0 9100 952 A1 and EP 0 913 090 A1 disclose the use of copper salts in addition to comparatively high amounts of oxidizing agents for the stabilization of isothiazolinones.

In addition to the 3:1 mixtures of CMIT and MIT described at the beginning, a mixture of methyl-4-isothiazolin-3-one and 1,2-benzisothiazolin-3-one (BIT) has gained importance as a biocide in recent years. This biocide is described, for example, in European Published Application EP 1 005 271 A1 and commercially available under the trade name ACTICIDE™ MBS. Due to the comparatively high stabilities of the isothiazolinones MIT and BIT, a particular stabilization of this biocide does not appear to be necessary, yet discoloration and precipitation can still be observed, especially in the event of prolonged storage at elevated temperatures in the region of 30° C.

The international patent application WO 2011/003906 A1, for example, is concerned with overcoming this disadvantage. This document describes how biocidal agents containing merely MIT and BIT as isothiazolinone should be stabilized with the help of 1 to 500 ppm by weight of copper(II) ions, in relation to the total weight fraction of isothiazolinones. However, the effect claimed in this document could not be verified in comparative experiments. In the context of the comparative experiments that were carried out, it was determined that aqueous biocidal agents containing 5% 2-methyl-2H-isothiazol-3-one by weight and 5% 1,2-benzisothiazolin-3-one by weight could not be stabilized by adding 50 ppm by weight or 250 ppm by weight of Cu²⁺ ions, in relation to the content of isothiazolinones.

Thus, the objective was to provide a stabilized MIT and BIT-containing biocidal composition.

This objective is achieved by a composition comprising:
(A) 2.5 to 15% of isothiazolinones 2-methyl-2H-isothiazolin-3-one and 1,2-benzisothiazolin-one by weight and/or their sodium and/or potassium salt,
(B) 0.5 to 50 ppm by weight of copper(II) ions, in relation to the proportion by weight of the component (A),
(C) 100 to 2,500 ppm by weight, in relation to the total composition, of at least one oxidizing agent selected from the group consisting of sodium iodate, potassium iodate, sodium bromate and potassium bromate or mixtures thereof, and
(D) water.

In the context of the invention, it has been found that the above-defined compositions are particularly stable when stored and that, compared with the prior art compositions, the decomposition of the biocides 2-methyl-2H-isothiazolin-3-one and 1,2-benzisothiazoline-one is effectively prevented. Furthermore, hardly any precipitation and discoloration can be observed in the compositions according to the invention.

Within the meaning of the present invention, compositions are biocidal concentrates used for the preservation of technical products. Such compositions are preferably liquid and water-based. For that matter, “liquid” means that, at room temperature, the composition is in the liquid state of aggregation and the content of solid or undissolved constituents is 0 to 1% by weight, preferably 0 to 0.5% by weight. Particularly preferred, the compositions are completely free of solid or undissolved constituents.

The compositions according to the invention contain, as component (A), 2.5 to 15%, preferably 5-10% of both isothiazolinones 2-methyl-2H-isothiazolin-3-one and 1,2-benzisothiazolin-one by weight and/or their sodium and/or potassium salt. According to a preferred embodiment of the invention, the concentrates contain only 2-methyl-2H-isothiazolin-3-one and 1,2-benzisothiazolin-one and/or their sodium and/or potassium salt as isothiazolinones. The 1,2-benzisothiazolinone is preferably used in the form of its sodium and/or potassium salts. The creation of the alkali metal salts of 1,2-benzisothiazolin-one is usually carried out by reacting 1,2-benzisothiazolin-one with the corresponding alkali metal hydroxide, whereat typically 0.7 to 1.2 molar equivalents of the alkali metal hydroxide, in relation to the 1,2-benzisothiazolin-one, preferably 0.8 to 1.1 molar equivalents, are used. When calculating the content of the two isothiazolinones 2-methyl-2H-isothiazolin-3-one and 1,2-benzisothiazolin-one, the content of free 1,2-benzisothiazolin-one is included in the calculation.

The weight ratio of the isothiazolinones 2-methyl-2H-isothiazolin-3-one and 1,2-benzisothiazolin-one can vary across a wide range. Preferably the weight ratio of 2-methyl-2H-isothiazolin-3-one and 1,2-benzisothiazolin-one is in the range of 3:1 to 1:3, more preferably in the range of 1:2 to 2:1.

According to a particularly preferred embodiment of the invention, the composition contains only the two isothiazolinones 2-methyl-2H-isothiazolin-3-one and 1,2-benzisothiazolin-one and/or their sodium and/or potassium salt as isothiazolinones.

The composition according to the invention contains components (B) and (C) for its stabilization.

For component (B), the composition according to the invention contains 0.5 to 50 ppm copper(II) ions by weight, preferably 1 to 35 ppm copper(II) ions by weight, particularly preferred 1 to 20 ppm copper(II) ions by weight, in relation to the weight fraction of component (A), i.e. the total weight fraction of isothiazolinones 2-methyl-2H-isothiazolin-3-one and 1,2-benzisothiazolin-one in the composition.

The source of the copper(II) ions contained in the composition is all water-soluble copper(II) salts or complexes. Generally, the copper salt is selected from the group consisting of copper sulfate, copper acetate, copper chloride, copper bromide, copper chlorate, copper perchlorate, copper nitrite and copper nitrate, or mixtures of said compounds. According to a preferred embodiment of the invention, copper nitrate is used to prepare the composition of the invention.

The composition (C) according to the invention contains 100 to 2,500 ppm by weight, in relation to the total composition, of at least one oxidizing agent selected from the group consisting of sodium iodate, potassium iodate, sodium bromate and potassium bromate or mixtures thereof. With respect to the maximum content of the oxidizing agent in the composition according to the invention, no more than 500 ppm has proven advantageous in the use of the composition with respect to sodium iodide and/or potassium iodate and no more than 2,000 ppm with respect to sodium bromate and/or potassium bromate. Thus, when the compositions were properly used in polymer emulsions, it was observed that compositions with a respectively high content of oxidizing agent contributed to the occurrence of discoloration in the inks.

According to a preferred embodiment of the invention, the composition contains 100 to 2,500 ppm by weight, in relation to the total composition, of at least one oxidizing agent selected from the group consisting of sodium iodate, potassium iodate, sodium bromate and potassium bromate or mixtures thereof, whereat the content of sodium iodate and/or potassium iodate is in the range of 100 to 500 ppm and the content of sodium iodate and/or potassium iodate is in the range of 100 to 2,000 ppm.

According to a preferred embodiment of the invention, the composition as component (C) exclusively contains one or more oxidation agents selected from the group consisting of sodium iodate, potassium iodate, sodium bromate and potassium bromate or mixtures thereof. According to a more preferred embodiment of the invention, the composition contains sodium and/or potassium iodate as oxidizing agent in an amount ranging from 100 to 500 ppm by weight, in relation to the total composition. According to an alternatively preferred embodiment of the invention, the composition contains sodium and/or potassium bromate as oxidizing agent in an amount ranging from 100 to 2,500 ppm by weight, preferably in the range of 500-2,000 ppm by weight, in relation to the total composition.

The content of water, i.e. component (D) of the composition, can vary across a wide range and is generally 85 to 97.5% by weight, preferably about 90% by weight. According to a preferred embodiment of the invention, the composition contains demineralized or softened water as component (D).

Preferred compositions are those which are substantially free of organic solvents. “Substantially free of organic solvents” in the context of the invention means a weight fraction of organic solvent in the composition ranging from 0-3% by weight, preferably in the range of 0-1% by weight, more preferably complete absence of organic solvents.

In a preferred embodiment, the composition according to the invention has a nitrate content of 1000 ppm by weight or less, preferably 500 ppm by weight or less, more preferably 50 ppm by weight or less, in relation to the total weight of the composition. In another embodiment, the nitrate content of the composition is less than 20 ppm by weight.

The pH of the composition is generally in the range of 8 to 11, preferably in the range of 8.2 to 9.2.

For production reasons, the isothiazolinones contained in the composition generally contain a certain proportion of common salt, which can then also be found in the composition. Thus, due to the corrosive nature of the chloride ions contained in the common salt, compositions with NaCl content by weight are in the range of 0 to 2.8% by weight, preferably in the range of 0 to 2% by weight, alternatively preferably in the range of 0 to 60% by weight, in relation to the composition contained in the 2-methyl-2H-isothiazolin-3-one.

For production reasons, the isothiazolinones contained in the composition may generally contain a certain proportion of Ca²⁺ ions, which can then be found in the composition. Furthermore, component (D), the water, allows for introducing additional Ca²⁺ ions, which may total more than 10 ppm by weight, in relation to the composition, and may result in precipitation of active ingredient.

Therefore, it has been found to be particularly advantageous if the composition is further characterized in that it contains
(E) 0 to 10 ppm by weight, preferably 0 to 8 ppm, particularly preferred 0 to 2 ppm Ca²⁺ ions, in relation to the total composition.

Thus, according to a particularly preferred embodiment, the invention relates to a composition comprising:
(A) 2.5 to 15% of isothiazolinones 2-methyl-2H-isothiazolin-3-one and 1,2-benzisothiazolin-one by weight and/or their sodium and/or potassium salt,
(B) 0.5 to 50 ppm copper(II) ions by weight, in relation to the weight fraction of component (A)
(C) 100 to 2,000 ppm by weight, in relation to the total composition, of at least one oxidizing agent selected from the group consisting of sodium iodate, potassium iodate, sodium bromate and potassium bromate or mixtures thereof,
(D) water and
(E) 0 to 10 ppm by weight, preferably 0 to 8 ppm, more preferably 0 to 2 ppm Ca²⁺ ions, in relation to the total composition.

Within the scope of the present invention, such compositions proved to be particularly storage stable with respect to the formation of precipitation and condensation.

As an alternative to the embodiment described above, it has also proved to be advantageous if the composition according to the invention contains one or more complexing agents. Complexing agents in the present case are compounds capable of binding Ca²⁺ ions. This can be used to reduce the hardness of the water and to complex the interfering calcium ions.

Therefore, it has been found to be particularly advantageous if the composition is further characterized in that it contains
(E) 10 to 500 ppm, preferably 50 to 200 ppm of at least one complexing agent by weight, in relation to the total composition.

For the purposes of the present invention, “at least one complexing agent” means that the composition contains one, two, three, four or more complexing agents. Generally, particularly well-suited complexing agents are compounds capable of binding Ca²⁺ ions. According to a preferred embodiment of the invention, the at least one complexing agent is selected from the group consisting of methylglycinediacetic acid (MGDA), ethylenediaminetetraacetic acid (EDTA), nitrilotriacetic acid (NTA), tripolyphosphate (TPP), citrates, phosphonates and crown ethers or mixtures thereof. Particularly preferred complexing agents are EDTA, NTA and MGDA.

In addition to 2-methylisothiazolin-3-one and 1,2-benzisothiazolin-3-one, the composition according to the invention may contain one or more additional biocidal active substances selected based on the field of application. According to a preferred embodiment, the composition according to the invention further contains N-methyl-1,2-benzisothiazolin-3-one in addition to the two isothiazolinones. According to a particularly preferred embodiment of the invention, in addition to the two isothiazolinones, the composition according to the invention also contains N-methyl-1,2-benzisothiazolin-3-one in an amount ranging from 1 to 7.5% by weight, preferably 2.5 to 5% by weight, in relation to the total composition. According to an embodiment, the composition according to the invention further contains only 2-methyl-2H-isothiazol-3-one, 1,2-benzisothiazolin-3-one and N-methyl-1,2-benzisothiazolin-3-one.

The composition of the present invention can be prepared by mixing the ingredients in any order while stirring.

The composition according to the invention is particularly suitable for the preservation of technical materials susceptible to infestation by microorganisms.

The invention therefore also relates to the use of the composition according to the invention for the protection of industrial materials against attack by and for the control of microorganisms, and a method for the protection of industrial materials against attack and/or destruction by microorganisms, which is characterized in that the composition according to the invention is allowed to act on the microorganism or its habitat. The action can occur in diluted or undiluted form.

The invention also relates to technical materials obtainable by treatment of technical materials with the composition according to the invention, as well as technical materials containing the composition according to the invention.

Preferred technical materials are functional fluids and hydrous technical products, such as, for example, paints, interior paints, lacquers, glazes, plasters, interior plasters, emulsions, latices, polymer dispersions, precursors and intermediates of the chemical industry, for example in dye production and storage, lignosulfonates, chalk slurries, mineral slurries, ceramic compounds, adhesives, sealants, casein products, starchy products, bituminous emulsions, surfactant solutions, fuels, washing agents, cleaning agents, detergents and cleaners for industry and household, pigment pastes and pigment dispersions, inks, lithographic liquids, thickeners, cosmetic products, toiletries, water cycles, paper processing fluids, leather manufacturing fluids, textile manufacturing fluids, drilling and cutting oils, hydraulic fluids and coolants. According to a preferred embodiment of the invention, the product is selected from the group consisting of interior paints, interior plasters, polymer dispersions and cosmetic products.

The particular application concentration of the composition according to the invention depends on the nature and occurrence of the microorganisms to be controlled, the initial microbial load and on the composition of the technical material to be protected.

The optimum amount used for the particular application can be determined prior to the practical application in a manner well-known to those skilled in the art and by means of test series in the laboratory. Generally the use concentrations in relation to the two isothiazolinones are in the range of 10 to 500 ppm, preferably in the range of 50 to 300 ppm, in relation to the material to be protected.

The particular advantage of the invention is that a long-term stability of the biocidal composition of the invention can be achieved with small amounts of copper(II) ions in conjunction with small amounts of oxidizing agent(s), and in comparison with unstabilized biocidal compositions, drug degradation, discoloration and failure of decomposition products can effectively be prevented, or at least significantly reduced.

The following comparative examples and examples explain the invention.

### COMPARATIVE EXAMPLE 1: COMPOSITIONS STABILIZED WITH CU(II) IONS

In order to verify that disclosure in European Patent EP-B 2 272 348 is effective, the comparative experiments described below were carried out:

Sample A (Unstabilized)

569.8 g of demineralized water were initially produced, mixed with 17.86 g of an aqueous sodium hydroxide solution (50 wt.-%), and 21.6 g of sodium chloride, and stirred until everything had dissolved. 42.38 commercial wet BIT (84.94 wt.-%) were added to this and stirred at room temperature until everything had dissolved.

72.0 g of an aqueous MIT solution (49.89 wt.-%) were subsequently added to this solution while stirring. This resulted in a clear, almost colorless solution with a pH of 8.6.

Samples B and C (Supposedly Stabilized)

Preparation of sample B: 100.0 g of sample A described above were initially produced and 0.10 g of a 1.83% solution of copper(II) nitrate trihydrate (corresponding with 0.5% Cu²⁺) added while stirring.

Preparation of sample C: 100.0 g of sample A described above were initially produced and 0.50 g of a 1.83% solution of copper(II) nitrate trihydrate (corresponding with 0.5% Cu²⁺) added while stirring.

This resulted in clear, almost colorless solutions with a pH of 8.6.

The three samples were stored at 65° C. and after 5 days the appearance was evaluated. The results are shown in Table 1.

TABLE 1

| | Sample A | Sample B | Sample C |
|---|---|---|---|
| | (0 ppm Cu²⁺) | 50 ppm Cu²⁺ * | 250 ppm Cu²⁺ * |
| Appearance | Black solution | Black solution | Black solution |
| | with yellow | with yellow | with yellow |
| | sediment | sediment | sediment |

* in relation to the total weight content of isothiazolinones

As can be seen from the results shown in Table 1, aqueous compositions containing 5 wt.-% MIT and 5 wt.-% BIT can not be satisfactorily stabilized by the addition of 50 ppm by weight (sample B) and 250 ppm by weight (sample C) Cu²⁺ ions in relation to the content of isothiazolones, contrary to the disclosure of EP 2 272 348.

### EXAMPLE 1: STABILIZATION OF COMPOSITIONS CONTAINING POTASSIUM IODATE Isothiazolinones with Various Amounts of Cu(II) Ions

The samples defined in Table 2 were prepared using demineralized water, aqueous sodium hydroxide solution, commercial wet BIT, aqueous MIT solution (ACTICIDE M 25S), copper(II)-nitrate-trihydrate solution, and potassium iodate or potassium bromate respectively. Clear, almost colorless solutions with a pH of 8.6 were obtained. The individual samples were stored at 65° C. and their appearance rated after 5 days. The results are shown in Table 2.

TABLE 2

| BIT | MIT | Total IT | Cu²⁺ | | |
|---|---|---|---|---|---|
| [%] | [%] | [%] | [ppm*] | KIO₃[ppm] | Appearance |
| 5 | 5 | 10 | 50 | — | Discoloration, sediment |
| 5 | 5 | 10 | 50 | 30 | Discoloration, sediment |
| 5 | 5 | 10 | 75 | 250 | green precipitates |
| 5 | 5 | 10 | 0.25 | 250 | Discoloration, sediment |
| 5 | 5 | 10 | 0.5 | 250 | clear solution |
| 5 | 5 | 10 | 1 | 250 | clear solution |
| 5 | 5 | 10 | 20 | 250 | clear solution¹ |
| 5 | 5 | 10 | 50 | 250 | clear solution |
| 2.5 | 2.5 | 5 | 1 | 250 | clear solution |
| 2.5 | 5 | 7.5 | 1 | 250 | clear solution¹ |
| 2.5 | 5 | 7.5 | 75 | 250 | green precipitates |
| 2.5 | 5 | 7.5 | 50 | 250 | clear solution |

| BIT | MIT | Total IT | Cu²⁺ | KBrO₃ | |
|---|---|---|---|---|---|
| [%] | [%] | [%] | [ppm*] | [ppm] | Appearance |
| 5 | 5 | 10 | 1 | 250 | clear solution |
| 2.5 | 2.5 | 5 | 1 | 250 | clear solution |

*in relation to the total weight fraction of isothiazolinones; total IT: Isothiazolinone content [% by weight];
¹to a small extent white precipitates

As can be seen from Table 2, isothiazolinone compositions containing 250 wt. Ppm of potassium iodate can be stabilized by adding 0.5 to 50 wt. ppm of Cu²⁺ ions, in relation to the weight fraction of isothiazolinone.

### EXAMPLE 2: STABILIZATION OF CU(II) ION-CONTAINING COMPOSITIONS WITH VARIOUS AMOUNTS OF OXIDIZING AGENTS

The samples defined in Table 3 were prepared using demineralized water, aqueous sodium hydroxide solution, commercial wet BIT, aqueous MIT solution (ACTICIDE M 25S), copper(II)-nitrate-trihydrate solution, and potassium iodate or sodium bromate respectively. Clear, almost colorless solutions with a pH of 8.6 were obtained. The individual samples were stored at 65° C. and their appearance rated after 5 days. The results are shown in Table 3.

TABLE 3

| BIT | MIT | Total IT | Cu²⁺ | | |
|---|---|---|---|---|---|
| [%] | [%] | [%] | [ppm*] | KIO₃[ppm] | Appearance |
| 5 | 5 | 10 | 20 | 50 | Discoloration, sediment |
| 5 | 5 | 10 | — | 250 | Discoloration, sediment |
| 5 | 5 | 10 | 20 | 100 | clear solution |
| 5 | 5 | 10 | 20 | 250 | clear solution¹ |
| 5 | 5 | 10 | 20 | 500 | clear solution |

| BIT | MIT | Total IT | Cu²⁺ | NaBrO₃ | |
|---|---|---|---|---|---|
| [%] | [%] | [%] | [ppm*] | [ppm] | Appearance |
| 5 | 5 | 10 | 20 | 50 | Discoloration, sediment |
| 5 | 5 | 10 | — | 500 | Discoloration, sediment |
| 5 | 5 | 10 | 20 | 100 | clear solution |
| 5 | 5 | 10 | 20 | 500 | clear solution |
| 5 | 5 | 10 | 20 | 1.000 | clear solution¹ |
| 5 | 5 | 10 | 20 | 2.000 | clear solution |

*in relation to the total weight fraction of isothiazolinones; total IT: Isothiazolinone content [% by weight];
¹to a small extent white precipitates

As can be seen from the results shown in Table 3, a Cu²⁺ ion-containing composition can be stabilized using 100 to 500 ppm potassium iodate or 100 to 2000 ppm potassium bromate.

### EXAMPLE 3: IMPACT OF CA²⁺ IONS ON THE STABILITY OF THE COMPOSITIONS

As can be seen from Examples 1 and 2, in some samples stabilized by means of Cu²⁺ ions and iodate or bromate, white precipitates could be observed. As demonstrated by the following experiments, the cause of the occurrence of these precipitations is the total concentration of Ca²⁺ ions in the respective sample. Ca²⁺ ions can make their way into the composition by various means, thus for production reasons, the isothiazolinones contained in the composition may generally contain a certain proportion of Ca²⁺ ions, which can then be found in the composition. Also, the solvent water can allow for introduction of Ca²⁺ ions into the composition, which can lead to the occurrence of precipitates.

To investigate the extent to which the content of Ca²⁺ ion influences the storage stability of the compositions, the subsequent experiments were carried out.

The samples defined in Table 4 were prepared using demineralized water, aqueous sodium hydroxide solution, commercial wet BIT or BIT repeatedly washed with demineralized water, aqueous MIT solution (ACTICIDE M 25 S), copper(II)-nitrate-trihydrate solution, and potassium iodate or potassium bromate respectively, in each case with a potassium iodate content of 250 ppm, and the respective Ca²⁺ contents determined. Clear, almost colorless solutions with a pH of 8.6 were obtained. The individual samples were stored at 65° C. and their appearance rated after 5 days. The results are shown in Table 4.

TABLE 4

| BIT | MIT | EDTA | Cu²⁺ | Ca²⁺ | |
|---|---|---|---|---|---|
| [%] | [%] | [ppm] | [ppm*] | [ppm] | Appearance |
| 5 | 5 | — | 20 | 14 | clear solution¹ |
| 2.5 | 5 | — | 1 | 12 | clear solution¹ |
| 2.5 | 5 | 100 | 1 | 12 | clear solution |
| 5 | 5 | 50 | 20 | 12 | clear solution |
| 5 | 5 | 200 | 20 | 12 | clear solution |
| 5² | 5 | — | 20 | 2 | clear solution |
| 5² | 5 | — | 20 | 10 | clear solution |
| 2.5² | 5 | — | 1 | 4 | clear solution |

*in relation to the total weight fraction of isothiazolinones; total IT: Isothiazolinone content [% by weight];
¹to a small extent white precipitates;
²repeatedly washed with deionized water

As can be seen from the results shown in Table 4, the total concentration of Ca²⁺ ions influences the stability of the respective samples. As can be seen, stability can be further improved by either adding a complexing agent or by reducing the total content of Ca²⁺ ions to 10 ppm by weight or less.

1. Composition containing:
(A) 2.5 to 15% of isothiazolinones 2-methyl-2H-isothiazolin-3-one and 1,2-benzisothiazolin-one by weight and/or their sodium and/or potassium salt,
(B) 0.5 to 50 ppm by weight of copper(II) ions, in relation to the proportion by weight of the component (A),
(C) 100 to 2,500 ppm by weight, in relation to the total composition, of at least one oxidizing agent selected from the group consisting of sodium iodate, potassium iodate, sodium bromate and potassium bromate or mixtures thereof, and
(D) water.

2. Composition according to claim 1, characterized in that the composition further contains:
(E) 0 to 10 ppm by weight Ca²⁺ ions, in relation to the total composition.

3. Composition according to claim 1, characterized in that the composition further contains:
(E) 10 to 500 ppm by weight of at least one complexing agent, in relation to the total composition

4. Composition according to claim 1,
characterized in that the weight ratio of the isothiazolinones 2-methyl-2H-isothiazolin-3-one and 1,2-benzisothiazolin-one is between 3:1 and 1:3.

5. Composition according to claim 1,
characterized in that the composition contains only 2-methyl-2H-isothiazolin-3-one and 1,2-benzisothiazolin-one as isothiazolinones.

6. Composition according to claim 1, characterized in that it contains a weight fraction of organic solvents of 0 to 3% by weight.

7. Composition according to claim 1, characterized in that it contains a weight fraction of NaCl in the range of 0 to 2.8% by weight.

8. Composition according to claim 1, characterized in that it exhibits a pH value in the range of 8 to 11.

9. Composition according to claim 1, characterized in that the content of sodium iodate and/or potassium iodate is in the range of 100 to 500 ppm and the content of sodium bromate and/or potassium bromate is in the range of 100 to 2,000 ppm.

10. Use of the composition according to claim 1 for the protection of industrial materials against attack by and non-therapeutic control of microorganisms.

11. Process for the protection of industrial materials against attack and/or destruction by microorganisms, characterized in that a composition according to claim 1 is allowed to act on the microorganism or its habitat.

12. Technical materials obtainable by treating technical materials with the composition according to claim 1.
